(19) United States
(12) Patent Application Publication
(10) Pub. No.: US 2004/0203520 A1
(43) Pub. Date: Oct. 14, 2004

(54) Apparatus and method for application control in an electronic device

(76) Inventors: Tom Schirtzinger, Fontana, WI (US); Michael Charlier, Palatine, IL (US); Daniel Wong, Wildwood, IL (US)

Correspondence Address: MOTOROLA INC, 600 NORTH US HIGHWAY 45, ROOM AS437, LIBERTYVILLE, IL, 60048-5343, US

(21) Appl. No.: 10/326,516

(22) Filed: Dec. 20, 2002

(51) Int. Cl. H04B 1/38; H04M 1/00

(52) U.S. Cl. 455/90.3; 455/550.1

(57) ABSTRACT

An apparatus and method for application control in an electronic device. The electronic device can include a housing including a housing face, a display coupled to the housing face, the display having a first display side and a second display side opposite the first display side, a navigational speaker coupled to the housing face on the first display side, and a public speaker. The navigational speaker can include a first speaker and a multidirectional input device coupled to the first speaker. The electronic device can also include a microphone coupled to the housing face on the second display side.

### CROSS-REFERENCE TO RELATED APPLICATIONS

This application is related to an application directed to Motorola case number CS21445RL, entitled “Apparatus and Method for Electronic Device Control,” which is hereby incorporated by reference, filed on even date herewith, and commonly assigned to the assignee of the present application.

### BACKGROUND OF THE INVENTION

1. Field of Invention

The present invention is directed to a method and apparatus for application control in an electronic device. In particular, the present invention is directed to input devices and sound generating devices in an electronic device.

2. Description of Related Art

Presently, many different applications are being incorporated into small electronic devices. For example, mobile communication devices are incorporating gaming applications and personal digital assistants are incorporating communication applications. When a mobile communication device employs a gaming application, the game must use the existing input devices on the mobile communication device. For example, an existing telecommunications keypad and an existing navigational input must be used for gaming control on a mobile communication device.

Unfortunately, the small size of some electronic devices limits the available inputs for multiple applications. As mentioned, the controls for a game on a mobile communication device are limited to the limited number of existing inputs such as keys and buttons. These inputs are not placed in optimal positions for efficient gaming or navigation control. Furthermore, to conserve space, these inputs are small and congested due to the small size of many electronic devices. Thus, optimal use of the inputs is difficult due to their size and location. Also, the inputs may be placed in close proximity to the audio output of the electronic device. Unfortunately, this may cause a user's hands to muffle the audio output of the device.

Thus, there is a need for an electronic device with improved tactile input and audio output functionality.

### BRIEF DESCRIPTION OF THE DRAWINGS

The preferred embodiments of the present invention will be described with reference to the following figures, wherein like numerals designate like elements, and wherein:

FIG. 1 is an exemplary illustration of an electronic device according to a first embodiment;

FIG. 2 is an exemplary block diagram of the electronic device according to a preferred embodiment;

FIG. 3 is an exemplary illustration of an electronic device according to a second embodiment;

FIGS. 4-6 are exemplary illustrations of an electronic device according to a third embodiment;

FIG. 7 is an exemplary illustration of an electronic device according to a fourth embodiment;

FIG. 8 is an exemplary illustration of a navigational speaker according to a first embodiment;

FIG. 9 is an exemplary illustration of a side view of a navigational speaker according to a second embodiment;

FIG. 10 is an exemplary illustration of a navigational speaker according to a third embodiment;

FIG. 11 is an exemplary illustration of a navigational speaker according to a fourth embodiment;

FIG. 12 is an exemplary illustration of a navigational speaker according to a fifth embodiment; and

FIG. 13 is an exemplary flowchart outlining the operation of the electronic device according to a preferred embodiment.

### DETAILED DESCRIPTION OF PREFERRED EMBODIMENTS

The invention provides an apparatus and method for application control in an electronic device. The electronic device can include a housing including a housing face, a display coupled to the housing face, the display having a first display side and a second display side opposite the first display side, a navigational speaker coupled to the housing face on the first display side, and a public speaker coupled to the housing. The navigational speaker can include a first speaker and a multidirectional input device coupled to the first speaker. The electronic device can also include a microphone coupled to the housing face on the second display side. The first speaker can cover the multidirectional input device. Also, the multidirectional input device can cover the first speaker and the multidirectional input device can include a first side on a speaker side of the multidirectional input device, a second side opposite to the first side, and an aperture acoustically coupling the speaker to an exterior of the second side of the multidirectional input device. The electronic device can also include a tactile input device coupled to the housing face on the second display side. For example, a tactile input device can be any device that senses touch, pressure, motion, or the like. The electronic device can additionally include a navigational input coupled to the housing face on the second display side. The electronic device can further include a controller configured to enable the multidirectional input device when the electronic device is in an application mode and to disable the multidirectional input device when the electronic device is in a phone mode. For example, a phone mode can include providing for mobile communications and display of related information. Also, an application mode can provide gaming functions, scheduling functions, word processing functions, or any other application functions.

The electronic device can also include a controller configured to enable the first speaker when the electronic device is in a phone mode and to disable the first speaker when the electronic device is in an application mode. The controller can also enable the second speaker when the electronic device is in an application mode and disable the second speaker when the electronic device is in a phone mode.

The electronic device can also include a sensor configured to sense an orientation of the electronic device. The controller can configure an orientation of the multidirectional input device and an orientation of the display based on the sensed orientation of the electronic device. The controller can further configure an orientation of the multidirectional input device and an orientation of the display to a first orientation based on a phone mode of the electronic device and to configure an orientation of the multidirectional input device and an orientation of the display to a second orientation based on an application mode of the electronic device.

The housing can be a first housing and the electronic device can further include a second housing rotatably coupled to the first housing and a sensor configured to detect a position of the first housing. The controller can enable the multidirectional input device when the sensor detects the housing face is in a first position and disable the multidirectional input device when the sensor detects the housing face is rotated into a second position indicating a private mode of operation. The display can include a landscape mode and a portrait mode. The controller can further enable the landscape mode of the display when the sensor detects the housing face is in a first position and enable the portrait mode of the display when the sensor detects the housing face is rotated into a second position. The electronic device can also include a receiver configured to receive an incoming communication. The controller can additionally pause an executing application and answer the incoming communication when the sensor detects a change in position of the first housing. The electronic device can further include a caller identification module coupled to the first housing, the caller identification module configured to display a caller identification of an incoming call. The controller can also pause an executing application and display the caller identification using the caller identification module when the sensor detects a change in position of the first housing. The electronic device can additionally include a trigger coupled to a side of the second housing and coupled to the controller. The controller can map the trigger to perform a trigger function based on a selected application.

According to another embodiment, the present invention provides a mobile communication device. The mobile communication device can include a housing including a housing face, a controller, a transceiver coupled to the controller, a display coupled to the housing face, the display also coupled to the controller, the display having a first side of the display, and a second side of the display opposite the first side of the display, a navigational speaker coupled to the housing face on the first side of the display, and a microphone coupled to the housing on the second side of the display. The navigational speaker can include a first speaker coupled to the controller and at least one sensor coupled to the speaker and the controller, the at least one sensor configured to detect at least one tactile input or at least two different tactile inputs, such as two directional inputs. The mobile communication device can also include a second speaker coupled to the controller. The controller can enable the first speaker for a private telecommunications operation and enable the second speaker for an application operation. The controller can also enable the at least one sensor for an application operation and disable the at least one sensor for a private telecommunications operation. The housing can be a first housing. The mobile communication device can further include a second housing rotatably coupled to the first housing, a button coupled to a side of the second housing, and a controller coupled to the button, the controller configured to map the button to perform a trigger function.

According to another embodiment, the present invention provides a method of operating a mobile communication device having a navigational speaker and a public speaker. The method can include outputting audio through a navigational speaker, detecting an application requiring the use of navigational input via the navigational speaker, outputting audio through a public speaker, and receiving navigational input via the navigational speaker. The method can also include detecting an incoming call, providing an alert of the incoming call, sensing the movement of a mobile communication device flip from a first position, and pausing an executing application. The method can additionally include sensing the return of the mobile communication device flip to the first position and resuming execution of the application. The method can further include sensing the swiveling of the mobile communication device flip to a phone state and answering the incoming call. The method can also include disabling navigational input via the navigational speaker and outputting audio through the navigational speaker. The method can additionally include detecting a state of a swivel mounted flip and adjusting a display orientation based on the state of the swivel mounted flip. The method can further include detecting an orientation of the mobile communication device and adjusting a display orientation and a navigational speaker input orientation based on the orientation of the mobile communication device.

Among other benefits, the present invention can solve a problem with combining a speaker with navigation keys. In particular, such a combination allows the inadvertent activation of the navigation keys when a user places the speaker against the user's ear. The problem can be solved in a flip phone by deactivating the multidirectional input when a flip is in a face down phone state and by activating the multidirectional input when the flip is in a face up application and/or gaming state. This problem can also be solved in a candy bar phone by only activating the multidirectional input when in a application or gaming state or when the phone is in a landscape position.

Another problem that can be solved by the present invention is the covering of the navigational speaker by a user's fingers when the multidirectional input is used. The problem can be solved by switching the audio output from the private navigational speaker to a higher fidelity, amplified public or alternate speaker residing in a separate portion of the electronic device.

Another benefit of the present invention can be allowing the swivel and rotation state of a flip to configure a display orientation and a user interface behavior. For example, a face down position can provide a phone style user interface and portrait display configuration and a face up position can provide an application and/or gaming user interface and landscape display configuration. Opening and closing the flip from the face down to and from the phone position can allow for answering and ending calls.

Another benefit of the present invention can be allowing the placement of the navigational speaker on one side of the display and the placement of other tactile inputs such as keys on buttons on another side of the display. Such placement can allow the operation of navigational input with one hand and action input with the other hand. For example, in a gaming application, one hand can navigate a character and the other hand can provide action inputs for the character.

Another benefit of the present invention can be enhanced handling of caller identification for incoming calls. For example, flip and swivel behavior can be used to present a user with an incoming caller's phone number. The user can then be allowed to acknowledge or ignore the incoming call. For example, when the user is playing a game application and an incoming call is detected, an alert can be activated such as a ring tone or a vibration. The user can then have three options. First, the user can freeze the game and answer the call by opening and swiveling the flip in one motion and then continue the game when the call is complete. Second, the user can freeze the game and check the caller identification by raising the flip but not swiveling the display. The user then has a choice of answering the call by swiveling the flip over to a phone mode. Alternately, the user can decide to ignore the call and return to the game by dropping the flip back into a gaming position. Third, the user can ignore the call and continue the game without raising the flip.

Another benefit of the present invention can be allowing all of the above navigational speaker functions for many applications, including gaming applications, personal digital assistant applications, messaging applications, or any other applications that use a navigational input. For example, by using a display that allows both swiveling and rotation, the display can be placed in an outward facing position on a flip-style phone to utilize a personal digital assistant application. Freezing a personal digital personal digital assistant application state during flip or swivel state transitions and keeping a personal digital assistant application mode and a phone mode independent of each other can provide for the impression of two different devices in one small electronic device. The display can include a touch screen for character and handwriting recognition and the navigational speaker can be used to navigate applications and play game applications.

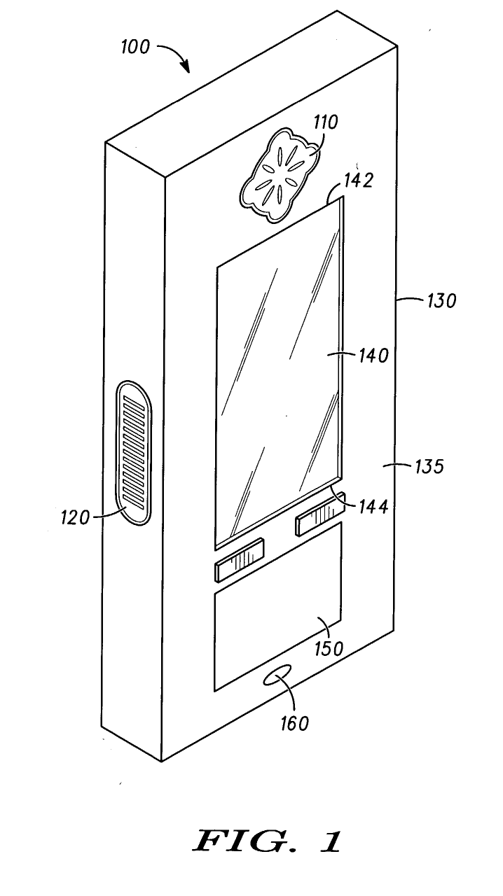

FIG. 1 is an exemplary illustration of an electronic device 100 according to a first embodiment. The electronic device 100 can include a navigational speaker 110, a second speaker 120, a housing 130, a housing face 135, a display 140 having a first display side 142 and a second display side 144, a tactile input 150, and an audio input device 160. The navigational speaker 110, the display 140, and tactile input 150 and the audio input device 160 may be mounted on the housing face 135. Also, the navigational speaker 110 may be mounted on an opposite side of the display 140 from the tactile input 150 and the audio input device 160. The second speaker 120 may be mounted on a side of the electronic device 100. For example, the second speaker 120 can be mounted on the housing face 135, any side perpendicular to the housing face 135, the back of the electronic device 100, or any other location on the housing 130. The electronic device 100 is shown in a portrait mode of operation. For example, in a portrait mode of operation, typically the display 140 is taller than it is wide. Also, in the portrait mode of operation, the navigational speaker 110 may be located at the top of the display 140 and the audio input device 160 may be located at the bottom of the display 140. The entire electronic device 100 may also be taller than it is wide in the portrait mode of operation. Additionally, the electronic device 100 may be used as a telecommunications device in a phone mode in the portrait mode of operation.

The electronic device 100 may be a mobile communication device, a portable telecommunication device, a personal digital assistant, an electronic gaming device, or any other electronic device. The navigational speaker 110 may include any combination of a speaker and a multidirectional input device coupled to the speaker. The audio input 160 may be a microphone or any other device useful for audio input. The tactile input 150 may include a keypad, a touchpad, a sensor, a navigational input, buttons, or any other tactile input devices.

In operation, the electronic device 100 may operate in different modes of operation. For example, the electronic device may operate applications in an application mode of operation. These applications can include gaming applications, communications applications, personal digital assistant applications, and any other applications operable on an electronic device. In the application mode, the electronic device 100 may be kept in a portrait mode or may be rotated into a landscape mode. For example, in the landscape mode, the display 140 and the electronic device 100 may be wider than they are tall. Also, in the landscape mode, the navigational speaker 110 and the audio input device 160 may be located at the sides of the display 140. In the application mode, the navigational speaker 110 may be used to enter data and commands to the electronic device 100. For example, the navigational speaker 110 can be used to move a mouse or a cursor indicator on the display 140. Also, the navigational speaker 110 can be used to control a game character, control a viewpoint, or control any other application parameters. For example, in a first person viewpoint game, the navigational speaker 110 can be used to control the view on the display 140. Additionally, the tactile input 150 may be used to control other aspects of a currently executing application. For example, the tactile input 150 can be used for data entry, for additional game character movement or viewpoint control, or for any other useful application input purposes. Because a user's fingers may cover the navigational speaker 110 during an application mode, an audio output of the navigational speaker 110 can be disabled and a multidirectional input can be enabled during an application mode of operation. Also, during the application mode, the second speaker 120 can be enabled for audio output. For example, the second speaker 120 may provide a public output with more power and fidelity than the navigational speaker 110.

The electronic device 100 may also operate in a phone mode of operation. In the phone mode of operation, the electronic device 100 can be used in a portrait mode. For example, for a private telecommunication operation, the navigational speaker 110 can be held to a user's ear for private audio output. Thus, a multidirectional input feature of the navigational speaker 110 may be disabled and an audio output feature of the navigational speaker 110 may be enabled for the phone mode of operation.

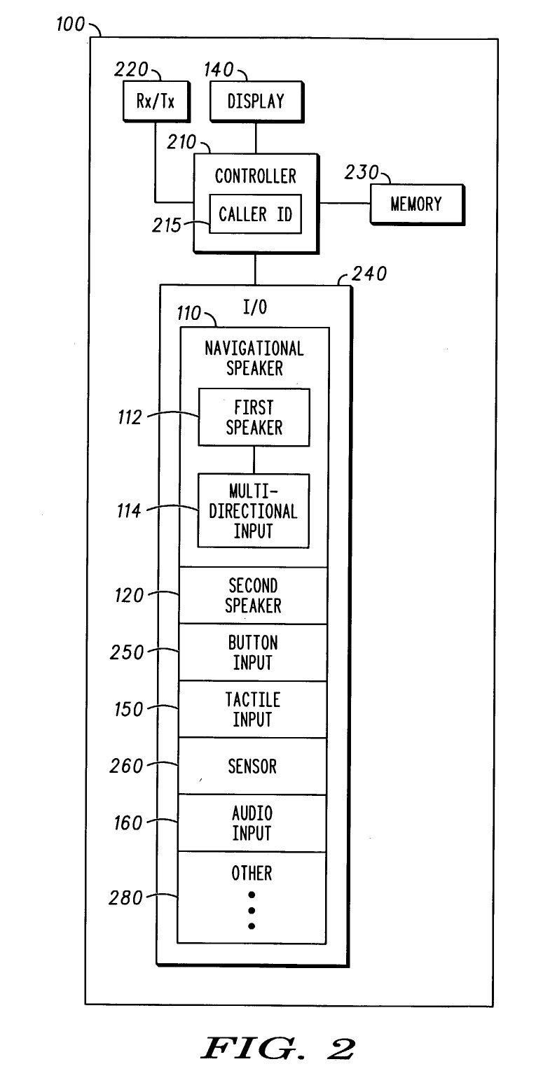

FIG. 2 is an exemplary block diagram of the electronic device 100 according to a preferred embodiment of the invention. This block diagram can illustrate the features of all embodiments disclosed herein. The electronic device 100 can include at least one display 140 a controller 210, a transceiver 220, a memory 230, and input and output circuitry 240. The controller 210 can include a caller identification module 215. The input and output circuitry 240 can include the navigational speaker 110, the second speaker 120, a button input 250, the tactile input 150, a sensor 260, the audio input 160, and other input and output circuitry 280. The navigational speaker 110 can include a first speaker 112 and a multidirectional input device 114. The transceiver 220 may include a transmitter and/or a receiver. The memory 230 can store commands and programs for the operation of the controller 210. The memory 230 can also store data related to different operations of the electronic device 100. The memory 230 may be a random access memory, a read only memory, a programmable logic device, or any other device useful for storing commands and data.

In operation, the controller 210 controls the operation of the electronic device 100. For example, the controller can enable the multidirectional input device 114 when the electronic device 100 is in an application mode and disable the multidirectional input device 114 when the electronic device 100 is in a phone mode. Also, the controller 210 can enable the first speaker 112 when the electronic device 110 is in a phone mode and disable the first speaker 112 when the electronic device 110 is in an application mode. Additionally, the controller 210 can enable the second speaker 120 when the electronic device 110 is in an application mode and disable the second speaker 120 when the electronic device 110 is in a phone mode.

The sensor 260 can sense an orientation of the electronic device 110 and the controller 210 can configure an orientation of the multidirectional input device 114 and an orientation of the display 140 based on the sensed orientation of the electronic device 110. For this purpose the sensor 260 may include a gyroscopic device, a gravity sensor, an accelerometer, a mercury sensor, or any other device for sensing the orientation of a device. For example, if the electronic device 110 is held in a landscape orientation, the sensor 260 can sense the orientation. The controller 210 can then adjust the display 140 to a landscape mode and configure the multidirectional input 114 and the tactile input 150 accordingly. If the electronic device 110 is rotated to a portrait mode, the sensor 260 can sense the orientation and the controller 210 can make the appropriate adjustments.

The controller 210 can further configure an orientation of the multidirectional input device 114 and an orientation of the display 140 to a first orientation based on a phone mode of the electronic device 110 and configure an orientation of the multidirectional input device 114 and an orientation of the display 140 to a second orientation based on an application mode of the electronic device 110. For example, if a user wishes to make a phone call, the controller 210 can set the display 140 to a portrait mode. If the user wishes to use an application optimized for a landscape setting, the controller 210 can set the display 140 to a landscape mode. The controller 210 may make these adjustments regardless of the orientation of the electronic device 110.

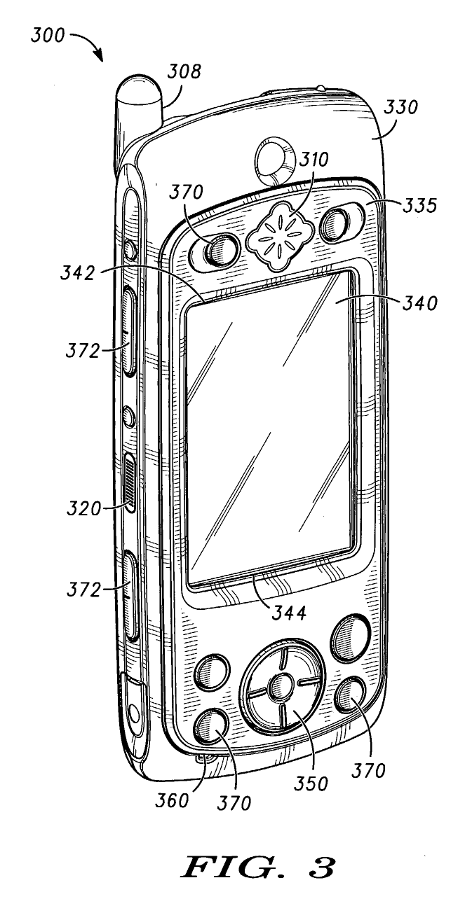

FIG. 3 is an exemplary illustration of an electronic device 300 according to a second embodiment. The electronic device 300 can include a navigational speaker 310, a second speaker 320, a housing 330, a housing face 335, a display 340 having a first display side 342 and a second display side 344, a tactile input 350, an audio input device 360, additional function keys or buttons 370 and 372, and an antenna 380. According to this embodiment, the electronic device 300 is shown in a landscape mode of operation. For example, in a landscape mode of operation, typically the display 340 is wider than it is tall. Also, in the landscape mode of operation, the navigational speaker 310 may be located at the side of the display 340 and the audio input device 360 may be located at the opposite side of the display 340. The landscape mode of operation can optimize the electronic device 300 for landscape oriented applications. These applications can include word processing applications, e-mail applications, messaging applications, certain gaming applications, and any other applications that can operate in a landscape mode. The antenna 380 can be used for mobile communication purposes.

The tactile input 350 may be a navigational input. Different inputs can be used depending on the requirements of a chosen application. For example, for a gaming application, the navigational speaker 310 can be used for movement, the tactile input 350 can be used for a viewing angle, and the additional function keys 370 and 372 can be used for action commands. For example, the function keys 372 can be used as trigger inputs for an action game.

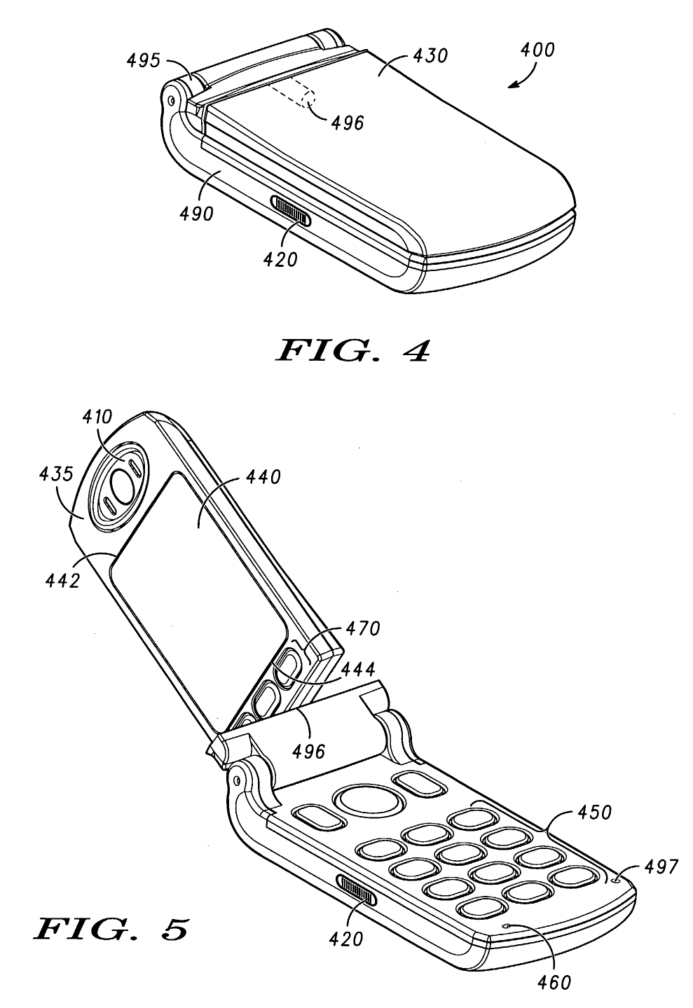

FIGS. 4-6 are exemplary illustrations of an electronic device 400 according to a third embodiment. The electronic device 400 can include a navigational speaker 410, a second speaker 420, a first housing 430 such as a flip housing, a first housing face 435, a display 440 having a first display side 442 and a second display side 444, a tactile input 450, an audio input device 460, additional function keys 470, and a sensor 497. The electronic device 400 can also include a second housing 490 mounted to the first housing 430 using a hinge 495 and swivel joint 496. As shown, the hinge 495 and swivel joint 496 rotatably couple the first housing 430 to the second housing 490. The sensor 497 can be located on a face of the second housing 490, in the hinge 495 and/or swivel joint 496, on the first housing 430, or any other location that allows the detection of a position of the first housing 430 relative to the second housing 490. Accordingly, the first housing 430 having the display 440 can pivot along two axial degrees of freedom relative to the second housing 490.

Thus, the sensor 497 can detect a position of the first housing 430. The controller 210 can then enable the multidirectional input device 114 when the sensor 497 detects the housing face 436 is in a first position and disable the multidirectional input device 114 when the sensor 497 detects the housing face 436 is rotated into a second position indicating a private mode of operation. For example, the controller 210 can disable the multidirectional input device 114 when the first housing 430 is opened for a phone configuration. The controller 210 can also enable a landscape mode of the display 440 when the sensor 497 detects the housing face 435 is in a first position and can to enable a portrait mode of the display 440 when the sensor 497 detects the housing face 435 is rotated into a second position. The receiver portion of the transceiver 220 can receive an incoming communication. The controller 210 can pause an executing application and answer the incoming communication when the sensor 497 detects a change in position of the first housing 430. The caller identification module 215 can display a caller identification of an incoming call on the display 440. The controller 210 can pause an executing application and display the caller identification on the display 440 using the caller identification module 215 when the sensor 497 detects a change in position of the first housing 430.

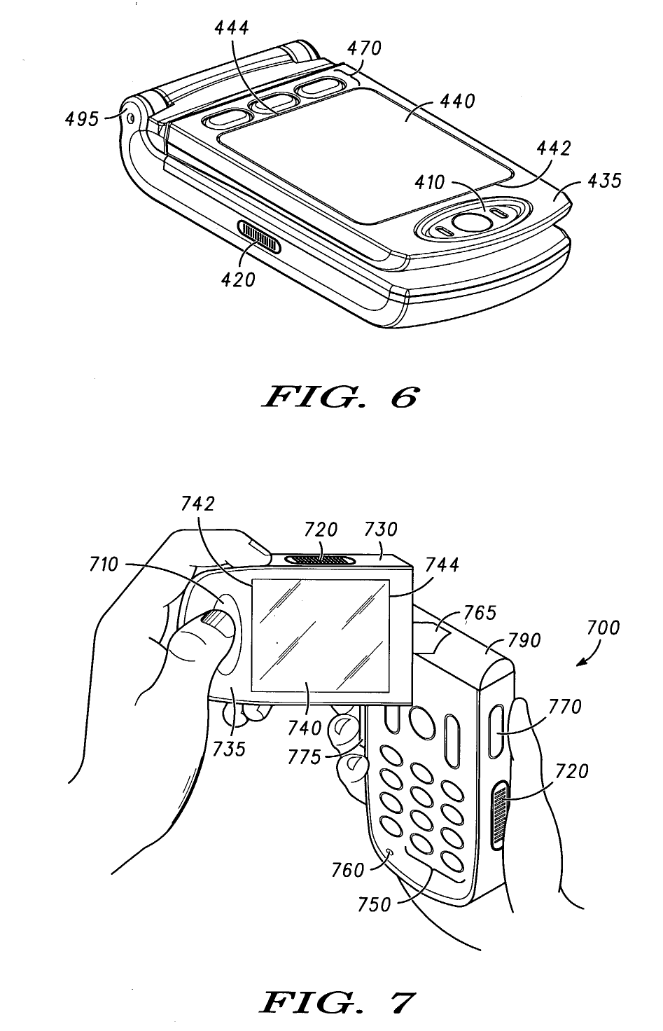

FIG. 7 is an exemplary illustration of an electronic device 700 according to a fourth embodiment. The electronic device 700 can include a navigational speaker 710, a second speaker 720, a first housing 730 such as a flip housing, a first housing face 735, a display 740 having a first display side 742 and a second display side 744, a tactile input 750, an audio input device 760, additional function keys 770, and a trigger 775. The trigger 775 may be a key, a button, a sensor, or any other device useful for detecting an input. The electronic device 700 can also include a second housing 790 mounted to the first housing 730 using rotatable coupling 765. The sensor 260 can detect a position of the first housing 730. The controller 210 can map the trigger 775 to perform a trigger function based on a selected application. For example, the trigger 775 may normally be used for selection and input functions for certain applications. Then, when a game application is selected, the controller 210 can map the trigger 775 to perform a trigger function for the selected game application.

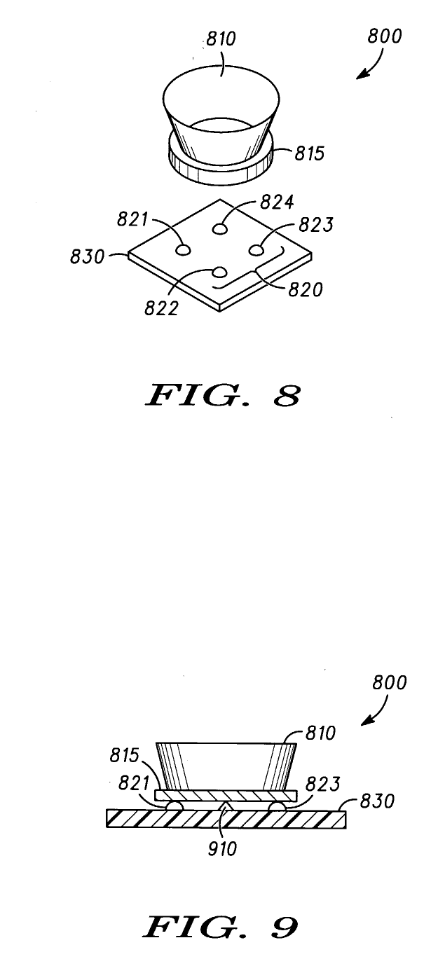

FIG. 8 is an exemplary illustration of a navigational speaker 800 according to a first embodiment. The navigational speaker 800 can include a speaker 810, a speaker mount 815, a multidirectional input 820 and an input mount 830. The multidirectional input 820 can include contact points 821-824. The contact points 821-824 may be switches, dome switches, buttons, membrane switches, or any other devices capable of sensing a contact.

FIG. 9 is an exemplary illustration of a side view of the navigational speaker 800 according to a second embodiment. The navigational speaker 800 can also include a pivot or fulcrum 910. The speaker 810 can be mounted to the speaker mount 815 and the multidirectional input 820 can be mounted to the input mount 830. In its natural position, the speaker mount 815 primarily only contacts the pivot 910. For example, the speaker mount 815 may be held in place by springs or may contact the multidirectional input 820 without placing significant pressure on the contact points 821-824. If pressure is placed on a side of the speaker 810, the speaker mount 815 can tilt on the pivot 910 and activate at least one of the contact points 821-824. The controller 210 can then detect the activation of at least one contact point 821-824 and generate an appropriate response for a navigational input.

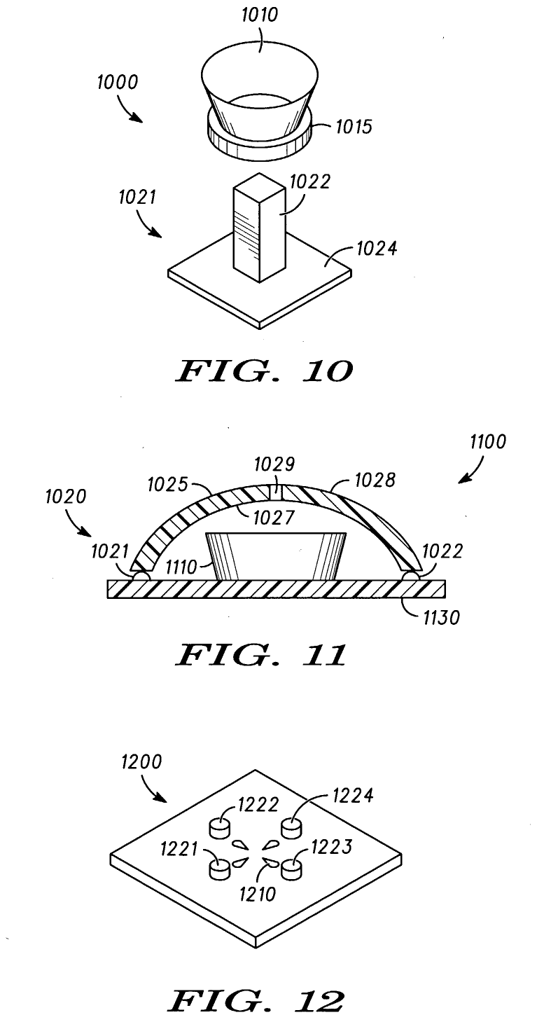

FIG. 10 is an exemplary illustration of a navigational speaker 1000 according to a third embodiment. The navigational speaker 1000 can include a speaker 1010, a speaker mount 1015, and a multidirectional input 1020. The multidirectional input 1020 can be a joystick-type of an input. Thus, the multidirectional input 1020 can include a shaft 1022 and a joystick encoder 1024. In operation, if pressure is placed on one side of the speaker 1010, the shaft 1022 is actuated accordingly which actuates contact points or the like in the encoder 1024. The controller 210 can then detect a signal from the encoder 1024 and generate an appropriate response for a navigational input.

FIG. 11 is an exemplary illustration of a navigational speaker 100 according to a fourth embodiment. The navigational speaker 1100 can include a speaker 1110, a multidirectional input 1020, and a mount 1130. The multidirectional input 1020 can include at least two contact points 1021 and 1022 and a cover 1025. The cover 1025 can have a first side 1027 on a speaker 1110 side and a second side 1028 opposite the first side. The cover 1025 can also include an aperture 1029 for acoustically coupling the speaker 1110 to an exterior of the cover 1025. If pressure is placed on a side of the cover 1025, the cover 1025 can activate at least one of the contact points 1021 and 1022. The controller 210 can then detect the activation of at least one of the contact points 1021 and 1022 and generate an appropriate response for a navigational input.

FIG. 12 is an exemplary illustration of a navigational speaker 1200 according to a fifth embodiment. The navigational speaker 1200 can include a speaker element 1210 under a speaker porting and multidirectional input buttons 1221-1224 that surround the speaker element 1210. In operation the speaker element 1210 can output audible or tactile signals. For example, as in all embodiments, the speaker element 1210, such as a speaker, can output sound. The speaker element 1210 can also output tactile information such as vibration information. The multidirectional input buttons 1221-1224 can be actuated for operation of the electronic device 100. The controller 210 can then detect the activation of at least one of the input buttons 1221-1224 and generate an appropriate response for a navigational input.

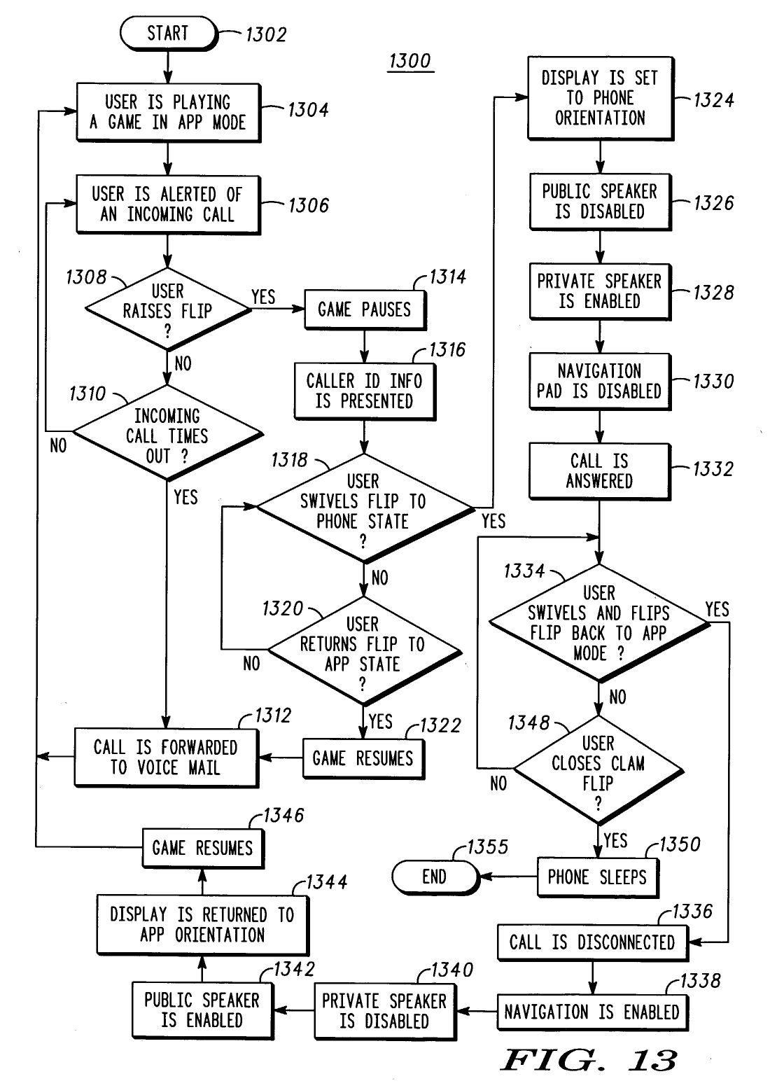

FIG. 13 is an exemplary flowchart 1300 outlining the operation of the electronic device 400 according to a preferred embodiment. In step 1302, the flowchart begins. In step 1304, a user of the electronic device 400 can be playing a game in an application mode. In step 1306, the user can be alerted of an incoming call. In step 1308, the electronic device 400 determines if the user has raised the first housing such as a flip 430 of the electronic device 400. If not, in step 1310, the electronic device 400 determines if the incoming call has timed out. If not, the electronic device 400 continues alerting the user of the incoming call in step 1306. If the incoming call has timed out, in step 1312, the electronic device 400 can forward the call to a voice mail system and return to step 1304.

If in step 1308, the electronic device 400 determines the user has raised the flip, the game pauses in 1314. In step 1316, the electronic device 400 displays caller identification information 1316. In step 1318, the electronic device 400 determines if the user has swiveled the flip 430 into a phone state. If the user has not swiveled the flip 430 into a phone state, in step 1320, the electronic device 400 determines if the user has returned the flip 430 to an application state. If not, the electronic device 400 continues to monitor the state of the flip 430 in step 1318. If the user returns the flip 430 to the application state, in step 1322 the game resumes and the electronic device 400 advances to step 1312. If in step 1318 the electronic device 400 determines the user has swiveled the flip 430 to a phone state, in step 1324, the display 440 is set to a phone orientation. In step 1326, the public speaker 420 is disabled. In step 1328, the private speaker 112 of the navigational speaker 410 is enabled. In step 1330, the multidirectional input 114 is disabled. In step 1332, the call is answered. In step 1334, the electronic device 400 determines if the user has swiveled and rotated the flip 430 back to an application mode. If so, the call is disconnected in step 1336. In step 1338, the multidirectional input 114 is enabled. In step 1340, the private speaker 112 is disabled. In step 1342, the public speaker 420 is enabled. In step 1344, the display 440 is returned to an application orientation and the game is resumed in step 1346.

If in step 1334 the electronic device 400 determines the user has not swiveled and rotated the flip 430 back to an application mode, in step 1348, the electronic device 400 determines if the user has closed the flip 430 without rotating it to an application state. If not, the electronic device 400 continues to monitor the state of the flip 430 in step 1334. If the user closes the flip 430 with the display 440 facing down, the phone sleeps in step 1350 and the flowchart ends in step 1355.

The method of this invention is preferably implemented on a programmed processor. However, the controller 210 may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this invention.

While this invention has been described with specific embodiments thereof, it is evident that many alternatives, modifications, and variations will be apparent to those skilled in the art. For example, various components of the embodiments may be interchanged, added, or substituted into the other embodiments. Accordingly, the preferred embodiments of the invention as set forth herein are intended to be illustrative, not limiting. Various changes may be made without departing from the spirit and scope of the invention.

What is claimed is:

1. An electronic device, comprising:
a housing including a housing face;
a display coupled to the housing face, the display having a first display side and a second display side opposite the first display side;
a navigational speaker coupled to the housing face on the first display side, the navigational speaker comprising:
a first speaker, and
a multidirectional input device coupled to the first speaker; and
a second speaker coupled to the housing.

2. The electronic device according to claim 1,
wherein the electronic device further comprises an audio input device coupled to the housing face on the second display side.

3. The electronic device according to claim 1,
wherein the first speaker covers the multidirectional input device.

4. The electronic device according to claim 1,
wherein the multidirectional input device covers the first speaker, and
wherein the multidirectional input device includes
a first side on a speaker side of the multidirectional input device,
a second side opposite to the first side, and
an aperture acoustically coupling the speaker to an exterior of the second side of the multidirectional input device.

5. The electronic device according to claim 1, further comprising a tactile input device coupled to the housing face on the second display side.

6. The electronic device according to claim 1, further comprising a navigational input coupled to the housing face on the second display side.

7. The electronic device according to claim 1, further comprising:
a controller configured to enable the multidirectional input device when the electronic device is in an application mode and to disable the multidirectional input device when the electronic device is in a phone mode.

8. The electronic device according to claim 1, further comprising:
a controller configured to enable the first speaker when the electronic device is in a phone mode and to disable the first speaker when the electronic device is in an application mode.

9. The electronic device according to claim 1, further comprising:
a controller configured to enable the second speaker when the electronic device is in an application mode and to disable the second speaker when the electronic device is in a phone mode.

10. The electronic device according to claim 1, further comprising:
a sensor configured to sense an orientation of the electronic device; and
a controller configured to adjust an orientation of the multidirectional input device and an orientation of the display based on the sensed orientation of the electronic device.

11. The electronic device according to claim 1, further comprising:
a controller configured to adjust an orientation of the multidirectional input device and an orientation of the display to a first orientation based on a phone mode of the electronic device and to configure an orientation of the multidirectional input device and an orientation of the display to a second orientation based on an application mode of the electronic device.

12. The electronic device according to claim 1,
wherein the housing is a first housing,
the electronic device further comprising:
a second housing rotatably coupled to the first housing;
a sensor configured to detect a position of the first housing; and
a controller configured to enable the multidirectional input device when the sensor detects the housing face is in a first position and configured to disable the multidirectional input device when the sensor detects the housing face is rotated into a second position indicating a private mode of operation.

13. The electronic device according to claim 1,
wherein the housing is a first housing, and
wherein the display includes a landscape mode and a portrait mode,
the electronic device further comprising:
a second housing rotatably coupled to the first housing;
a housing position sensor configured to detect a position of the first housing; and
a controller configured to enable the landscape mode of the display when the sensor detects the housing face is in a first position and configured to enable the portrait mode of the display when the sensor detects the housing face is rotated into a second position.

14. The electronic device according to claim 1,
wherein the housing is a first housing,
the electronic device further comprising:
a second housing rotatably coupled to the first housing;
a receiver configured to receive an incoming communication;
a sensor configured to detect a position of the first housing; and
a controller configured to pause an executing application and answer the incoming communication when the sensor detects a change in position of the first housing.

15. The electronic device according to claim 1,
wherein the housing is a first housing,
the electronic device further comprising:
a second housing rotatably coupled to the first housing;
a caller identification module coupled to the first housing, the caller identification module configured to display a caller identification of an incoming call;
a sensor configured to detect a position of the first housing; and
a controller configured to pause an executing application and display the caller identification using the caller identification module when the sensor detects a change in position of the first housing.

16. The electronic device according to claim 1,
wherein the housing is a first housing,
the electronic device further comprising:
a second housing rotatably coupled to the first housing;
a trigger coupled to a side of the second housing; and
a controller coupled to the trigger, the controller configured to map the trigger to perform a trigger function based on a selected application.

17. The electronic device according to claim 1, further comprising a controller configured to detect an orientation of the electronic device and adjust a display orientation and a navigational speaker input orientation based on the orientation of the electronic device.

18. A mobile communication device comprising:
a housing including a housing face;
a controller;
a transceiver coupled to the controller;
a display coupled to the housing face, the display also coupled to the controller, the display having a first side of the display, and a second side of the display opposite the first side of the display;
a navigational speaker coupled to the housing face on the first side of the display, the navigational speaker comprising:
a first speaker coupled to the controller, and
at least one sensor coupled to the speaker and the controller, the at least one sensor configured to detect at least one tactile input; and
a second speaker coupled to the housing.

19. The mobile communication device according to claim 18, wherein the second speaker is also coupled to the controller.

20. The mobile communication device according to claim 18, wherein the controller is configured to enable the first speaker for a private telecommunications operation and to enable the second speaker for an application operation.

21. The mobile communication device according to claim 18, wherein the controller is configured to enable the at least one sensor for an application operation and disable the at least one sensor for a private telecommunications operation.

22. The mobile communication device according to claim 18,
wherein the housing is a first housing,
the mobile communication device further comprising:
a second housing rotatably coupled to the first housing;
a button coupled to a side of the second housing; and
a controller coupled to the button, the controller configured to map the button to perform a trigger function.

23. The mobile communication device according to claim 18, further comprising a controller configured to detect an orientation of the mobile communication device and adjust a display orientation and a navigational speaker input orientation based on the orientation of the mobile communication device.

24. A method of operating a mobile communication device having a navigational speaker and a public speaker, the method comprising:
outputting audio through a navigational speaker;
detecting an application requiring the use of navigational input via the navigational speaker;
outputting audio through a public speaker; and
receiving navigational input via the navigational speaker.

25. The method of operating a mobile communication device according to claim 24, further comprising:
detecting an incoming call;
providing an alert of the incoming call;
sensing the movement of a mobile communication device flip from a first position; and
pausing an executing application.

26. The method of operating a mobile communication device according to claim 25, further comprising:
sensing the return of the mobile communication device flip to the first position; and
resuming execution of the application.

27. The method of operating a mobile communication device according to claim 25, further comprising:
sensing the swiveling of the mobile communication device flip to a phone state; and
answering the incoming call.

28. The method of operating a mobile communication device according to claim 27, further comprising:
disabling navigational input via the navigational speaker; and
outputting audio through the navigational speaker.

29. The method of operating a mobile communication device according to claim 24, further comprising:
detecting a state of a swivel mounted flip; and
adjusting a display orientation based on the state of the swivel mounted flip.

30. The method of operating a mobile communication device according to claim 24, further comprising:
detecting an orientation of the mobile communication device; and
adjusting a display orientation and a navigational speaker input orientation based on the orientation of the mobile communication device.
